(19) United States
(12) Patent Application Publication
(10) Pub. No.: US 2011/0308969 A1
(43) Pub. Date: Dec. 22, 2011

(54) REDUCING CORROSION AND WATER DECOMPOSITION ON A SURFACE OF A TITANIUM NITRIDE ELECTRODE

(75) Inventors: Ali Afzali-Azdakani, Ossining, NY (US); Shafaat Ahmed, Yorktown Heights, NY (US); Hariklia Deligianni, Tanafly, NJ (US); Stefan Harrer, New York, NY (US); Binquan Luan, Ossining, NY (US); Glenn J. Martyna, Croton-on-Hudson, NY (US); Hongbo Peng, (US); Stanislav Polonsky, (US); Stephen Rossnagel, (US); Xiaoyan Shao, Yorktown Heights, NY (US); Gustavo A. Stolovitzky, Riverdale, NY (US)

(73) Assignee: INTERNATIONAL BUSINESS MACHINES CORPORATION, Armonk, NY (US)

(21) Appl. No.: 12/820,574

(22) Filed: Jun. 22, 2010

(51) Int. Cl. G01N 17/04

(52) U.S. Cl. 205/776.5

(57) ABSTRACT

The present invention provides a method of reducing corrosion and water decomposition on a surface of an electrode having a titanium nitride conductive layer disposed on a substrate and estimating extent of reduction thereof. The electrode is immersed into a solution containing a hydroxyl-functional compound. Thereafter, a voltage is applied to the titanium nitride conductive layer of the electrode. The extent of oxidation of the titanium nitride conductive layer is correlated with the extent of formation of oxide of titanium nitride and/or the extent of oxidation of the titanium nitride conductive layer is correlated with the increase of surface roughness. The extent of water decomposition is correlated with formation of hydrogen and oxygen bubbles.

### CROSS-REFERENCE TO RELATED APPLICATIONS

This application is related to U.S. Patent Application 20080187915 filed Feb. 2, 2002, U.S. Patent Application 2010025249 filed Aug. 13, 2009, IBM Docket Number YOR920100340US1 entitled “FORMING AN ELECTRODE HAVING REDUCED CORROSION AND WATER DECOMPOSITION ON SURFACE USING A CUSTOM OXIDE LAYER” filed on ______ having Ser. No. ______ IBM Docket Number YOR920100341US1 entitled “FORMING AN ELECTRODE HAVING REDUCED CORROSION AND WATER DECOMPOSITION ON SURFACE USING AN ORGANIC PROTECTIVE LAYER” filed on ______ having Ser. No. ______, all incorporate herein by reference.

### BACKGROUND OF THE INVENTION

The field of the present invention relates generally to reducing corrosion and water decomposition and, more particularly, to reducing corrosion and water decomposition on a surface of a titanium nitride electrode and estimating the extent of the reduction thereof.

Electrochemical corrosion of an electrode causes deterioration of the electrode and reduced functionality. Further, if the electrode is immersed in an aqueous solution and a voltage is applied, then water decomposes forming oxygen and hydrogen bubbles on the surface of an electrode.

The use of polyethylene glycols and ionic liquids to electrochemically protect electrode surfaces against corrosion and water decomposition is known. However, there is a need in certain applications, for example in DNA-Transistors, for an improved non-hazardous and biocompatible material that provides corrosion protection and reduces water dissolution.

### BRIEF SUMMARY OF THE INVENTION

Accordingly, the present invention provides a method of reducing corrosion and water decomposition on a surface of an electrode having a titanium nitride conductive layer disposed on a substrate and estimating extent of reduction thereof. The electrode is immersed into a solution containing a hydroxyl-functional compound. Thereafter, a voltage is applied to the titanium nitride conductive layer of the electrode. The extent of oxidation of the titanium nitride conductive layer is correlated with the extent of formation of oxide of titanium nitride and/or the extent of oxidation of the titanium nitride conductive layer is correlated with the increase of surface roughness. The extent of water decomposition is correlated with formation of hydrogen and oxygen bubbles.

### BRIEF DESCRIPTION OF THE SEVERAL VIEWS OF THE DRAWINGS

FIG. 1 shows a diagram of a DNA-Transistor device.

FIG. 2 shows a flow chart for a method of reducing corrosion and water decomposition on a surface of an electrode having a titanium nitride conductive layer according to an embodiment of the present invention.

FIG. 3 shows an electrode used in the method according to an embodiment of the present invention.

### DETAILED DESCRIPTION OF THE INVENTION

Thin film electrodes are used in the emerging technology of DNA-Transistors. For a detailed explanation of DNA-Transistors see U.S. Patent Application 20080187915 and U.S. Patent Application 2010025249, both incorporated herein by reference.

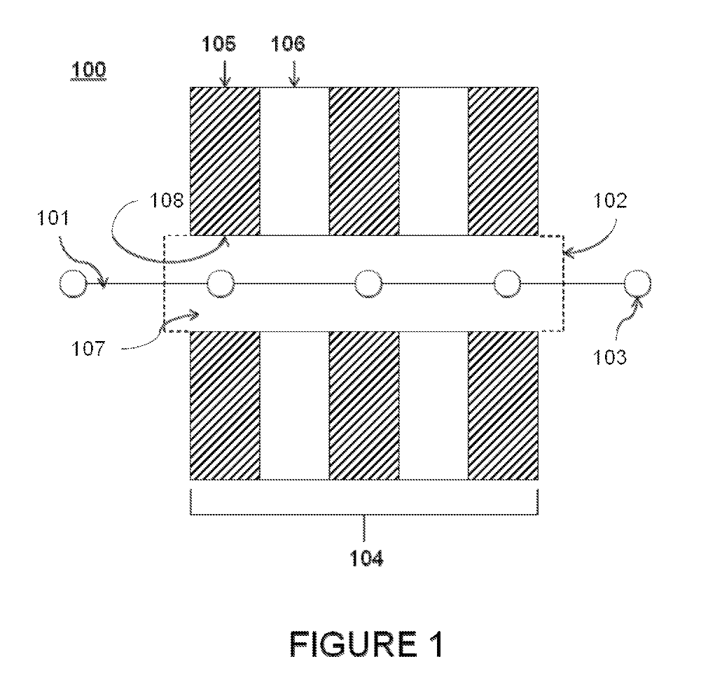

FIG. 1 shows a diagram of a DNA-Transistor device 100. The device 100 is capable of controlling the position of a DNA molecule 101 inside a nanopore 102 with single nucleotide accuracy. The device uses the interaction of charges 103 along the backbone of a DNA molecule 101 with an electric field created inside the nanopore 102. The nanopore 102 is drilled through a rack structure 104 of conductive layers 105 and dielectric layers 106 and then wetted with a solvent-electrolyte solution 107 carrying the DNA molecules 101. The surface areas of the conductive layers that are exposed to the solution 107 inside the nanopore 102 serve as electrodes 108 for generating and controlling the electric fields inside the nanopore 102. Voltages applied to the conductive layers 105 in the rack structure 104 allow for trapping and moving the DNA molecule 101 in the nanopore 102.

It is essential for maintaining functionality of the DNA-Transistor device 100 that the nanopore 102 dimensions are not spatially altered and continuous solution 107 flow inside the pore is not compromised during device operation. Specifically, this means that corrosion of the electrode 108 surface areas inside the nanopore 102 must be reduced and water decomposition catalyzed on the surface areas of electrodes 108 must be reduced.

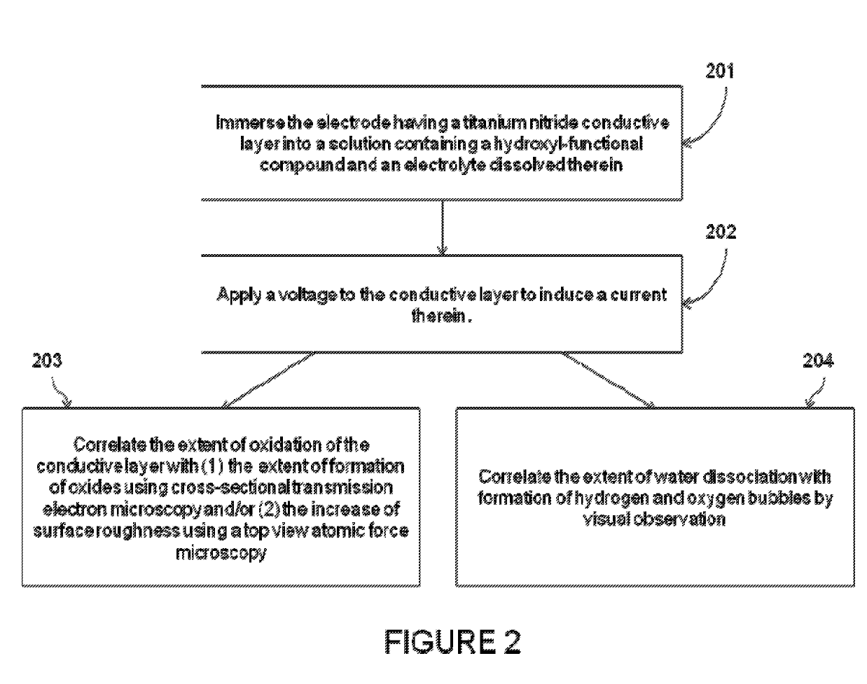

FIG. 2 shows a flow chart for a method of reducing corrosion and water decomposition on a surface of an electrode having a titanium nitride conductive layer according to an embodiment of the present invention.

In step 201 the electrode is immersed in a solution containing a hydroxl-functional compound and an electrolyte dissolved therein.

In order to inhibit corrosion and water decomposition, the solvent contains a hydroxyl-functional compound such as a linear, branched, or cyclic alcohol of 1 to 6 carbon atoms, ethylene glycol, propylene glycol, butane diol, pentane diol, hexan diol, polyethylene glycol, glycerol, trimethylol ethane, trimethylol propane, isomers thereof, aqueous solutions thereof, and mixtures any of the preceding hydroxyl-functional compounds. Preferably, the solution containing hydroxyl-functional compound has a viscosity from about 1 centi Stokes (cSt) to about 250 centi Stokes.

The electrolyte dissolved in the solvent can be a salt, an ammonium salt, a quaternary ammonium salt, a substantially dissociated compound, ionic liquids, and mixtures thereof. The electrolyte is preferably at a concentration from about 0.001 weight percent to about 10 weight percent.

Preferably, the solution also contains an organic solvent such as methanol, ethanol, propanol, butanol, ethylene glycol, ethyl acetate, 1,2-propanediol, 1,3-propanediol, diethyl ether, methyl ethyl ketone, methoxyethyl acetate, methoxypropyl acetate, methylene chloride, acetone, aliphatic hydrocarbons, aromatic hydrocarbons, and mixtures thereof.

Further, preferably the solvent also contains a solubility promoter such as dimethylsulfoxide, N,N-dimethylformaide, N,N-dimethylacetamaide, tri(dimethylamino)phosphine, tri(dimethylamino)phosphoramide, ethyl acetate, diethyl ether, methyl ethyl ketone, methoxyethyl acetate, methoxypropyl acetate, methylene chloride, acetone, and mixtures thereof.

In addition, in order to inhibit the electrochemical corrosion further, either a reducing agent or a buffering agent can be added to the solution.

In step 202 a voltage is applied to the conductive layer to induce a current therein. The current can be either AC or DC current.

In step 203 the extent of oxidation of the conductive layer is measured. Preferably, this is carried out by using cross-sectional transmission electron microscopy, cross-section scanning electron microscopy and/or using a top view atomic force microscopy.

In step 204 the extent of water decomposition is measured by visually observing the formation of hydrogen and oxygen bubbles.

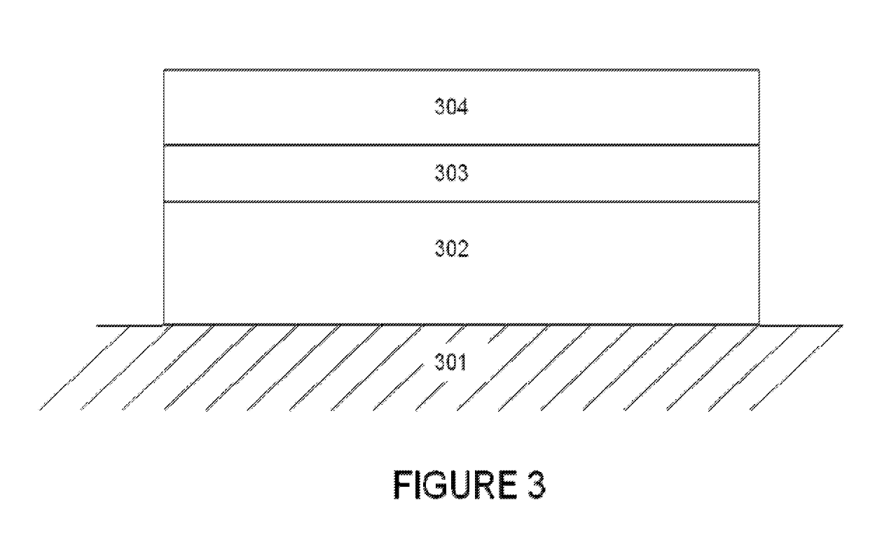

FIG. 3 shows an electrode used in the method according to an embodiment of the present invention. The substrate 301 serves as the medium onto which the titanium nitride conductive layer 302 is deposited. An oxide layer 303 can be formed on the titanium nitride conductive layer 302.

The substrate 301 can be any type of common substrate material such as Kapton, silicon, amorphous hydrogenated silicon, silicon carbide (SiC), silicon dioxide (SiO₂), quartz, sapphire, glass, metal, diamond-like carbon, hydrogenated diamond-like carbon, gallium nitride, gallium arsenide, germanium, silicon-germanium, indium tin oxide, boron carbide, boron nitride, silicon nitride (Si₃N₄), alumina (Al₂O₃), cerium(IV) oxide (CeO₂), tin oxide (SnO₂), zinc titanate (ZnTiO₂), AlGaAs, CN, InP, GaP, In_{0.53}Ga_{0.47}As, chalcogenides, a plastic material and a combination thereof.

The conductive layer 302 can be a metal, semiconductor or a doped semiconductor. Preferably, the conductive layer is titanium nitride; however, other conductive materials can be used. The conductive layer 302 can be a metal such as platinum, rhodium, gold, silver, zinc, titanium, ruthenium and aluminum. The conductive layer 302 can be a semiconductor such as GaAs, AlGaAs, NC, Ge, SiGe, InP, GaP, GaN, In_{0.53}Ga_{0.47}As and chalcogenides. The chalcogenide can be a compound of a metal such as Ge, Sn, Pb, Sb, Bi, Ga, In, TI and a combination thereof and a chalcogen such as S, Se, Te and a combination thereof. The conductive layer 105 can also be a doped semiconductor such as aluminum doped zinc oxide, phosphorus doped silicon, boron doped silicon, lanthanum doped zirconium dioxide, scandium doped zirconium dioxide, and yttrium doped zirconium dioxide. The conductive layer 302 can be deposited by any deposition process such as sputtering, molecular beam epitaxy, ion beam lithography and atomic layer deposition.

The oxide layer 303 can be formed through any known method of oxidation. An oxide layer 303 is not required for performing the method of inhibiting corrosion and water decomposition according to the present invention, however, an oxide layer 303 can be present.

In one aspect of the invention, an oxide layer 303 can be created by plasma oxidation in order to create an ultra-thin oxide layer 303. A preferred custom oxygen plasma process uses a working pressure of 150 mT, an oxygen flow rate of 100 sccm, a power of 40-200 W and a time of 0-80 seconds. The custom process provides a uniform oxide layer 303 free of surface defects. The thickness of the oxide layer 303 can be reduced to a thickness of 0.09 nm with a precision of 0.2 nm. It is beneficial that the oxide layer 303 be ultra-thin and highly uniform in application inside a nanopore. The custom oxygen plasma process can be applied not only to planar surfaces but also to topographically patterned surfaces isotropically oxidizing angled and vertical sidewalls as found inside a nanopore.

In another aspect of the invention, a protective layer 304 can be formed by self assembly of an organic surface active compound. The organic surface active compound has a structure which includes a polar end and a non-polar end. The polar end of the organic surface active compound forms a hydrogen bond with oxygen of the oxide layer 303 and the non-polar end forms the protective layer 304.

Preferably the protective layer 304 is a highly compact self assembled monolayer of a long chain organic phosphonic acid or hydroxamic acid. More specifically, the preferred organic surface active compound is represented by the formula:

R—(CH₂)ₙ—XH

wherein R is an alkyl group of 1-4 carbon atoms; n is from 0 to about 18; and —XH is a moiety selected from the group consisting of: —CONHOH, —COOH, —SO₂OH, —SOOH, —SO₂NHOH, —P(O)₂NHOH, —P(O₂)₂OH, —PO₃H, and mixtures thereof. The alkyl chains of phosphnoic or hyroxamic acids can also be partically or fully fluorinated to impart yet higher hydrophobicity on the exposed surface.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of reducing corrosion and water decomposition on a surface of an electrode having a titanium nitride conductive layer disposed on a substrate and estimating extent of reduction thereof, the method comprising:
immersing said electrode into a solution containing a hydroxyl-functional compound; thereafter
applying a voltage to said titanium nitride conductive layer of said electrode;
measuring an extent of oxidation of said titanium nitride conductive layer; and
measuring an extent of water decomposition.

2. The method of claim 1, wherein the step of measuring the extent of oxidation of said titanium nitride conductive layer is carried out by:
correlating the extent of oxidation of said titanium nitride conductive layer with extent of formation of oxides of titanium nitride; and/or correlating the extent of oxidation of said titanium nitride conductive layer with increase of surface roughness.

3. The method of claim 1, wherein the step of measuring the extent of water decomposition is carried out by correlating the extent of water decomposition with formation of hydrogen and oxygen bubbles.

4. The method of claim 1, wherein said hydroxyl-functional compound is selected from the group consisting of: a linear, branched, or cyclic alcohol of 1 to 6 carbon atoms, ethylene glycol, propylene glycol, butane diol, pentane diol, hexane diol, polyethylene glycol, glycerol, trimethylol ethane, trimethylol propane, isomers thereof, aqueous solutions thereof, and mixtures any of the preceding hydroxyl-functional compounds.

5. The method of claim 4, wherein said hydroxyl-functional compound further comprises a solubility promoter selected from the group consisting of: dimethylsulfoxide, N,N-dimethylformaide, N,N-dimethylacetamaide, tri(dimethylamino)phosphine, tri(dimethylamino)phosphoramide, ethyl acetate, diethyl ether, methyl ethyl ketone, methoxyethyl acetate, methoxypropyl acetate, methylene chloride, acetone, and mixtures thereof.

6. The method of claim 1, wherein said titanium nitride conductive layer is crystalline or bulk and is deposited by a method selected from the group consisting of: sputtering, molecular beam epitaxy, ion beam lithography, and atomic layer deposition.

7. The method of claim 1, wherein a current is applied to said conductive layer.

8. The method of claim 7, wherein said current is selected from the group consisting of: AC and DC currents.

9. The method of claim 1, wherein said substrate is selected from the group consisting of:
Kapton, silicon, amorphous hydrogenated silicon, silicon carbide (SiC), silicon dioxide (SiO₂), quartz, sapphire, glass, metal, diamond-like carbon, hydrogenated diamond-like carbon, gallium nitride, gallium arsenide, germanium, silicon-germanium, indium tin oxide, boron carbide, boron nitride, silicon nitride (Si₃N₄), alumina (Al₂O₃), cerium(IV) oxide (CeO₂), tin oxide (SnO₂), zinc titanate (ZnTiO₂), AlGaAs, CN, InP, GaP, In_{0.53}Ga_{0.47}As, chalcogenides, a plastic material and a combination thereof.

10. The method of claim 1, wherein said conductive titanium nitride layer comprises a plurality of individual conductive titanium nitride layers interrupted by at least one dielectric layer forming a rack.

11. The method of claim 1, further comprising:
adding an electrolyte into said solution.

12. The method of claim 11, wherein said electrolyte is a salt, an ammonium salt, a quaternary ammonium salt, a substantially dissociated compound, ionic liquids, and mixtures thereof.

13. The method of claim 12, wherein said electrolyte is at a concentration from about 0.001 weight percent to about 10 weight percent of said solution.

14. The method of claim 1, further comprising:
adding a reducing agent into said solution.

15. The method of claim 1, further comprising:
adding a buffering agent into said solution.

16. The method of claim 1, wherein the solution containing a hydroxyl-functional compound has a viscosity from about 1 centi Stokes (cSt) to about 250 centi Stokes.

17. The method of claim 1, wherein the step of correlating extent of oxidation of the titanium nitride conductive layer with extent of formation of oxides of titanium nitride is carried out using cross-sectional transmission electron microscopy.

18. The method of claim 1, wherein the step of correlating extent of oxidation of said titanium nitride conductive layer with increase of surface roughness is carried out using top view atomic force microscopy.

19. The method of claim 1, wherein the step of correlating extent of water decomposition with formation of hydrogen and oxygen bubbles is carried out by visual observation.
